(19) United States
(12) Patent Application Publication
(10) Pub. No.: US 2010/0238049 A1
(43) Pub. Date: Sep. 23, 2010

(54) COMMUNICATION SYSTEM

(75) Inventors: Yoshitaka Egawa, Tokyo (JP); Hiroshi Shima, Yokohama-shi (JP)

Correspondence Address: WOOD, HERRON & EVANS, LLP, 2700 CAREW TOWER, 441 VINE STREET, CINCINNATI, OH, 45202, US

(73) Assignee: HOCHIKI CORPORATION, Tokyo (JP)

(21) Appl. No.: 12/682,860

(22) PCT Filed: Oct. 2, 2008
(86) PCT No.: PCT/JP2008/067950

§ 371 Date: Apr. 13, 2010

(30) Foreign Application Priority Data
Oct. 17, 2007 (JP) 2007-270648

(51) Int. Cl. G08C 19/00

(52) U.S. Cl. 340/825.71

(57) ABSTRACT

A communication system of the present invention is provided with a transmitting unit and a receiving unit. The transmitting unit is provided with: a transmitting device that performs transmission of signals of a predetermined frequency; and a transmission control device that, through the transmitting device, transmits a first signal containing predetermined information, and a second signal that contains identification information for identifying the receiving unit, to which this first signal is to be transmitted, and that requires, for analyzing this signal, an amount of processing less than that required for the first signal. The receiving unit is provided with: a receiving device that detects the presence or absence of a signal of the predetermined frequency and receives the signal of the predetermined frequency; and a reception control device that, in a case where this receiving device has detected the signal of the predetermined frequency, controls the receiving device to receive the signal of the predetermined frequency only during a first period of time, that determines whether or not the signal received by the receiving device contains the second signal, and that, in a case where this second signal is contained, controls the receiving device to receive the signal of the predetermined frequency only during a second period of time, which is longer than the first period of time.

### TECHNICAL FIELD

The present invention relates to a communication system that performs communication by transmitting and receiving signals.

Priority is claimed on Japanese Patent Application No. 2007-270648, the contents of which are incorporated herein by reference.

### BACKGROUND ART

A conventional communication system is provided with: a transmitting unit that transmits signals; and a receiving unit that receives the signals transmitted from the transmitting unit, analyzes the content of the received signals, and performs a predetermined processing operation based on an analysis result thereof. For example, in a disaster prevention system that issues an alarm in a case where a fire, gas leakage, or the like is detected in a house, a disaster prevention receiving unit receives an alarm signal transmitted from a disaster prevention terminal of a fire detector or the like. Furthermore, this disaster prevention receiving unit performs audio output, on-screen display, and the like, based on the content of the received alarm signal.

In recent years, wireless units have become small in size, and there has been proposed a communication system in which such a wireless unit is provided in a disaster prevention terminal of a fire detector or the like to thereby perform wireless communications between a plurality of the disaster prevention terminals. In this communication system, the wireless unit wirelessly transmits, along with self identification information, start data indicating a start of an alarm state, failure state, or the like for the disaster prevention terminal, to the wireless unit of a plurality of other disaster prevention terminals. On the other hand, in a case where the wireless unit receives start data from another wireless unit, it performs predetermined processing based on the identification information received along with this start data (for example, refer to Patent Document 1 below).

[Patent Document 1] Japanese Unexamined Patent Application, First Publication No. 2007-94719

### DISCLOSURE OF THE INVENTION

### Problems to be Solved by the Invention

Incidentally, in the case of the above described disaster prevention terminal, if it is uncertain as to when the transmitting unit outputs a signal, the receiving unit needs to be in a stand-by state so that a signal to be transmitted from this transmitting unit can be received at any time. In general, the receiving unit intermittently performs an operation of detecting signals of a predetermined frequency used in the communication, and stands ready for signal transmissions from the transmitting unit. In a case where a signal of the predetermined frequency is detected in this detection operation, the receiving unit is made to perform a receiving operation, and the signal received by the receiving unit is subjected to an analyzing processing by a predetermined control unit.

However, a single communication system cannot make exclusive use of a signal frequency, and there is a possibility that another communication system may be using signals of the overlapping frequency. In a conventional communication system, even in a case where there is a signal transmitted from another communication system, if the frequency of the signal is the same as that of the signal used in the local system, the receiving unit will detect this signal and perform an operation of receiving this signal. Moreover, the control unit analyzes the content of the signal received by the receiving unit, and it determines whether or not subsequent processings will be required based on the content of the analyzed signal. In this case, the receiving unit at least needs to perform a receiving operation for a period of time, during which signals used in the local system can be received. For example, in the case of the wireless unit described above, the wireless unit needs to perform a receiving operation for a period of time during which signals containing identification information and start data can be received.

That is to say, in the conventional communication system, there is a need for performing operations required for receiving signals and analyzing the content thereof irrespective as to whether the signals belong to the local communication system or other communication systems, and therefore it is necessary, for a long period of time, to operate the receiving unit and the control unit for signals irrelevant to the local system. Therefore, consumption of electric power in the receiving unit and the control unit is increased in the conventional communication system. Such an increase in electric power consumption causes a reduction in the serviceable period of time of the wireless unit driven by a battery.

The present invention takes into consideration the above circumstances, and has an object of providing a communication system that enables reliable signal reception within the local system, reduces operation time of the receiving unit and control unit, and enables reduction in electric power consumption.

### Means for Solving the Problem

The present invention employs the following measures in order to solve the above problems and achieve the related object.

That is to say, (1) the present invention provides a communication system having a transmitting unit and a receiving unit. The transmitting unit is provided with: a transmitting device that performs transmission of a signal of a predetermined frequency; and a transmission control device that, through the transmitting device, transmits a first signal containing predetermined information, and a second signal that contains identification information for identifying the receiving unit, to which this first signal is to be transmitted, and that requires, for analyzing this signal, an amount of processing less than that required for the first signal. The receiving unit is provided with: a receiving device that detects the presence or absence of a signal of the predetermined frequency and receives the signal of the predetermined frequency; and a reception control device that, in a case where this receiving device has detected the signal of the predetermined frequency, controls the receiving device to receive the signal of the predetermined frequency only during a first period of time, that determines whether or not the signal received by the receiving device contains the second signal, and that, in a case where this second signal is contained, controls the receiving device to receive the signal of the predetermined frequency only during a second period of time, which is longer than the first period of time.

(2) There may be employed a configuration such that: the transmission control device repeatedly transmits the second signal only during a third period of time; and the reception control device controls the receiving device to detect the signal of the predetermined frequency for a second period, which is shorter than the third period of time, and in a case where the signal received by the receiving device contains the second signal, it controls the receiving device to receive the signal of the predetermined frequency only during the second period of time, which is longer than the third period of time.
(3) There may be employed a configuration such that: the transmitting unit, in each first period, repeatedly transmits the second signal only during a third period of time, which is shorter than the first period; and the reception control device controls the receiving device to detect the signal of the predetermined frequency in the second period, which is longer than the third period of time and is different from the first period, and in a case where the signal received by the receiving device contains the second signal, it controls the receiving device to receive the signal of the predetermined frequency only during the second period of time, which is longer than the first period of time and the third period of time.
(4) There may be employed a configuration such that the reception control device, in a case where the receiving device has detected the signal of the predetermined frequency several times, controls the receiving device to receive the signals of the predetermined frequency.

### EFFECT OF THE INVENTION

According to the communication system of the present invention, the receiving unit, in a case where it has detected a signal of the predetermined frequency, receives the signal during the first period of time, which is required for determining whether or not this signal contains the second signal. Then in a ease where this signal contains the second signal, it continues to perform the receiving operation and analysis of the content of the signal, and it receives the signal during the second period of time, which is longer than the first period of time. Therefore, in a case where the second signal is not contained, the receiving operation may be performed only during the first period of time and the amount of time for the receiving operation can be reduced. Consequently, it is possible to reduce electric power consumption of the receiving unit.

Moreover, the transmission control device repeatedly transmits the second signal for the third period of time, and the reception control device causes the signal detection to be performed in the second period, which is shorter than the third period of time. Therefore, the receiving unit, with the receiving device, can at least receive this second signal once in the third period of time, during which the second signal is being transmitted. Consequently, in the communication system of the present invention, in a case where a signal has been transmitted from the transmitting unit, the receiving unit can immediately detect this signal, receive and analyze the second signal, and receive the subsequent first signal. Hence, it is possible to improve real-time performance of the communication. Moreover, since the second period of time is longer than the third period of time, the reception control device, during the third period of time, can control the receiving device to continue to perform the receiving operation until the first signal, which is transmitted after the repeatedly transmitted second signal, has been received, to thereby reliably receive the first signal.

Moreover, the transmission control device controls the second signal to be repeatedly transmitted in each first period during the third period of time, and the reception control device controls signal detection to be performed for a period of time longer than the third period of time in the second period, which is different from the first period. Consequently, in a case where the timing of second signal transmission performed by the transmission control device matches the timing of signal detection performed by the reception control device, the receiving unit is capable, with the receiving device, of receiving the second signal. Accordingly, in the communication system of the present invention, it is possible to reduce the frequency of the signal detection operation performed by the receiving device, and to reduce electric power consumption. Moreover, since the second period of time is longer than the third period of time, the reception control device, during the third period of time, can control the receiving device to continue to perform the receiving operation until the first signal, which is transmitted after the repeatedly transmitted second signal, has been received, to thereby reliably receive the first signal.

Furthermore, in a case where the receiving device has detected the signal of the predetermined frequency a predetermined number of times, this receiving device is made to receive this signal. Accordingly, it is possible, only in a case where it is determined that the signal of the predetermined frequency is being reliably transmitted, to have the receiving device to perform the receiving operation. Consequently, it is possible to suppress the number of performances of the receiving operation to a bare minimum while reducing electric power consumption.

### BRIEF DESCRIPTION OF THE DRAWINGS

FIG. 1 is a block diagram functionally and conceptually showing an electrical configuration of a communication system according to an embodiment of the present invention.

FIG. 2 is a flowchart showing flows of processing executed by a control section in the same embodiment.

FIG. 3 is a timing chart showing timings of signal transmission/reception to be made between respective alarm units in the same embodiment.

FIG. 4 is a timing chart showing timings at which signal transmission/reception is made between the respective alarm units in the same embodiment.

FIG. 5 is a flowchart showing flows of processing executed by the control section in the same embodiment.

### DESCRIPTION OF REFERENCE SYMBOLS

1 Communication system
2 Alarm unit
3 Transmitting unit
4 Receiving unit
20 Sensor section
21 Notifying section
22 Recording section
23 Control section
30 Transmitting section
31 Transmission control section
40 Receiving section
41 Reception control section

### BEST MODE FOR CARRYING OUT THE INVENTION

Hereunder, respective embodiments of a communication system according to the present invention are described in detail, with reference to the accompanying drawings. First, [I] a fundamental concept that is common among the respective embodiments is described. Subsequently, [II] specific contents of the embodiments are described sequentially. Finally, [III] modified examples of the respective embodiments are described. However, the present invention is not to be considered limited only by these respective embodiments.

### [I] Fundamental Concept Common Among Respective Embodiments

First, a fundamental concept that is common among the respective embodiments is described. An object of a communication system according to the respective embodiment is to perform communications between a plurality of communication devices.

The subject of application of the communication system according to the respective embodiments is arbitrary, and for example, it may be applied to a home use alarm unit for detecting an occurrence of fire, gas leakage, or the like in a house and issuing an alarm, and mutual communications may be performed between a plurality of home use alarm units. Moreover, it may be applied to a disaster prevention system for a large scale structure such as an underground shopping arcade and a building structure, to perform mutual communications between a plurality of fire alarm units, monitoring sensors, or the like installed in these structures and a disaster prevention receiving device. Moreover, the form of communication is arbitrary, and there may be used communication systems including wireless communication, wired communication, optical communication, and the like.

One of the characteristics of the communication system according to the respective embodiments is that a transmitting unit transmits, as signals of a predetermined frequency, schematically: a first signal that contains predetermined information such as the state of a disaster prevention terminal and inspection instructions; and a second signal that contains identification information for identifying a receiving unit to which the first signal is to be transmitted. The second signal need only contain the identification information. Therefore, it is possible to make the amount of processing required for analyzing this second signal smaller than that required for the first signal.

The receiving unit detects the presence or absence of the signal of the predetermined frequency, and in a case where it has detected this signal of the predetermined frequency, first, determines whether or not this signal contains the second signal. In a case where the second signal is contained, it continues to perform the receiving operation and analyze the contents of the signal.

As described above, the receiving unit only operates for a period of time required for determining the presence or absence of the second signal, analysis of which requires a small amount of processing, and it further operates only in a case where the second signal is contained. Therefore, in this communication system, it is possible to reduce the operating time of the receiving unit to a bare minimum, and reduce electric power consumption.

### [II] Specific Contents of Respective Embodiments

Next, there are described specific contents of the respective embodiments according to the present invention. As mentioned above, the subject of application of the present invention is arbitrary, however, hereunder is a description with an example of a case where the present invention is applied to a communication system provided with a plurality of home use alarm units that wirelessly perform mutual communications therebetween.

### Embodiment 1

An embodiment 1 is described. In this embodiment, a receiving device performs signal detection in a period that is shorter than the time for transmission of the second signal performed by a transmitting device.

### (Configuration of Communication System)

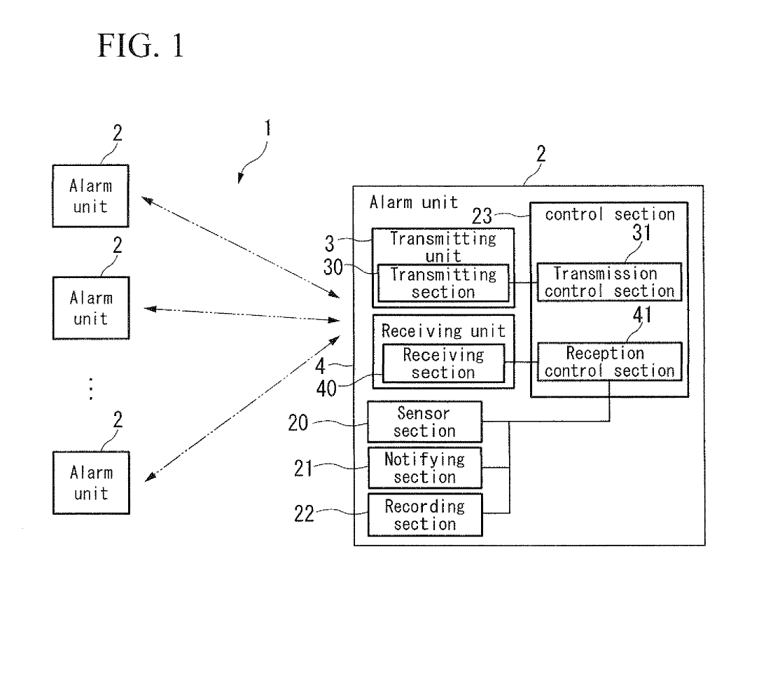

A configuration of the communication system is described. FIG. 1 is a block diagram that functionally and conceptually shows an electrical configuration of the communication system. As shown in the diagram, a communication system 1 is provided with a plurality of home use alarm units 2 (hereunder, referred to as “alarm units 2”). In this communication system 1, between the plurality of alarm units 2, there are performed communications of information such as: notification information for notifying an occurrence of fire, gas leakage, or the like; fault information of the alarm unit 2; and grouping information in a case of newly adding an alarm unit 2 to this communication system 1.

### (Configuration of Communication System—Alarm Unit 2)

The alarm unit 2 is provided with a transmitting unit 3, a receiving unit 4, a sensor section 20, a notifying section 21, a recording section 22, and a control section 23.

### (Configuration of Alarm Unit 2—Transmitting Unit 3)

The transmitting unit 3 is for transmitting a predetermined signal to another alarm unit 2, and is provided with a transmitting section 30 and a transmission control section 31. The transmitting section 30 is for transmitting a signal of a predetermined frequency, and corresponds to the transmitting device in the claims. The transmission control section 31 is for transmitting, via the transmitting section 30, a general signal containing predetermined information such as notification information described above, fault information, and the like, and a frame identification code containing identification information for identifying the receiving unit 4 to which the general signal is transmitted, and it corresponds to the transmission control device in the claims. Here, the specific contents of the general signal and frame identification code, and detailed control of the transmitting section 30 performed by the transmission control section 31, are described later. The specific configuration of the transmitting unit 3 is arbitrary, and it may employ a commonly known wireless transmitting device. Moreover, it is not always necessary to integrally provide the transmitting section 30 and the transmission control section 31, and for example, the transmission control section 31 may be provided as a part of the control section 23.

### (Configuration of Alarm Unit 2—Receiving Unit 4)

The receiving unit 4 is for detecting and receiving signals transmitted from the transmitting unit 3, and is provided with a receiving section 40 and a reception control section 41. The receiving section 40 detects the presence or absence of a signal of a predetermined frequency and receives this signal of the predetermined frequency, and it corresponds to the receiving device in the claims. The reception control section 41 controls the receiving section 40 so as to cause the receiving section 40 to receive the general signal and frame identification code, and it corresponds to the reception control device in the claims. The contents of the general signal and frame identification code, and detailed control of the receiving section 40 performed by the reception control section 41, are described later. The specific configuration of the receiving unit 4 is arbitrary, and it may employ a commonly known wireless receiving device. Moreover, it is not always necessary to integrally provide the receiving section 40 and the reception control section 41, and for example, the reception control section 41 may be provided as a part of the control section 23.

### (Configuration of Alarm Unit 2—Sensor Section 20)

The sensor section 20 detects a detection subject such as a fire, a gas leakage, or the like within a monitoring region where the alarm unit 2 is installed. The detection subject and the detection principle for this detection subject are arbitrary, and for example, smoke or heat that occurs as a result of a fire may be taken as a detection subject, and an electronic device such as an infrared LED, a photodiode, a thermistor, or the like may be used to detect these.

### (Configuration of Alarm Unit 2—Notifying Section 21)

The notifying section 21 performs a predetermined notification processing, based on information output from the control section 23. The specific contents of the notification processing is arbitrary, and there may be performed luminescent displaying with use of an LED, output of a buzzer sound, audio, or the like, electric signal output, or the like.

### (Configuration of Alarm Unit 2—Recording Section 22)

The recording section 22 stores predetermined information containing a frame identification code. The specific configuration of the recording section 22 is arbitrary, and for example, a nonvolatile recording device such as a memory IC may be used.

### (Configuration of Alarm Unit 2—Control Section 23)

The control section 23, in this embodiment, functionally and conceptually includes the transmission control section 31 and the reception control section 41 as part of constituents thereof. Moreover, the control section 23 performs information input/output and control with respect to the sensor section 20, the notifying section 21, and the recording section 22 described above. The details of the processing executed by the control section 23 are described later. The specific configuration of the control section 23 is arbitrary, however, for example, it is provided with a control program such as an OS (operating system), a program that defines procedures of various types of processings, a built-in memory for storing required data, and a CPU (central processing unit) that executes these programs.

### (General Signal and Frame Identification Code)

Next, the general signal and frame identification code are described.

The general signal is a signal containing predetermined information such as notification information and fault information, and it corresponds to the first signal in the claims. The specific contents of the general signal are arbitrary, however, for example, for identifying specific information that needs to be transmitted to another alarm unit 2, such as fire occurrence information detected by the alarm unit 2, which is the origin of the signal, an abnormal state of this alarm unit 2, or the like, it may be set as a signal that is associated with these types of information. Moreover, the data size of the general signal is arbitrary, however, it may be 100 bit data.

The frame identification code is a signal containing identification information for identifying the receiving unit 4 of the destination of the general signal, and it corresponds to the second signal in the claims. The specific content of the frame identification code is arbitrary, however, for example, in the same communication system 1, it may be set as a group code defined according to common rules and it is thereby possible to determine based on this frame identification code whether or not it belongs to the same communication system 1. Since the frame identification code may at least contain identification information, it is possible to make the data size of this frame identification code smaller compared to general information containing various types of information as described above, and for example, it may be set as S bit data.

### (Processing Performed by Control Section 23)

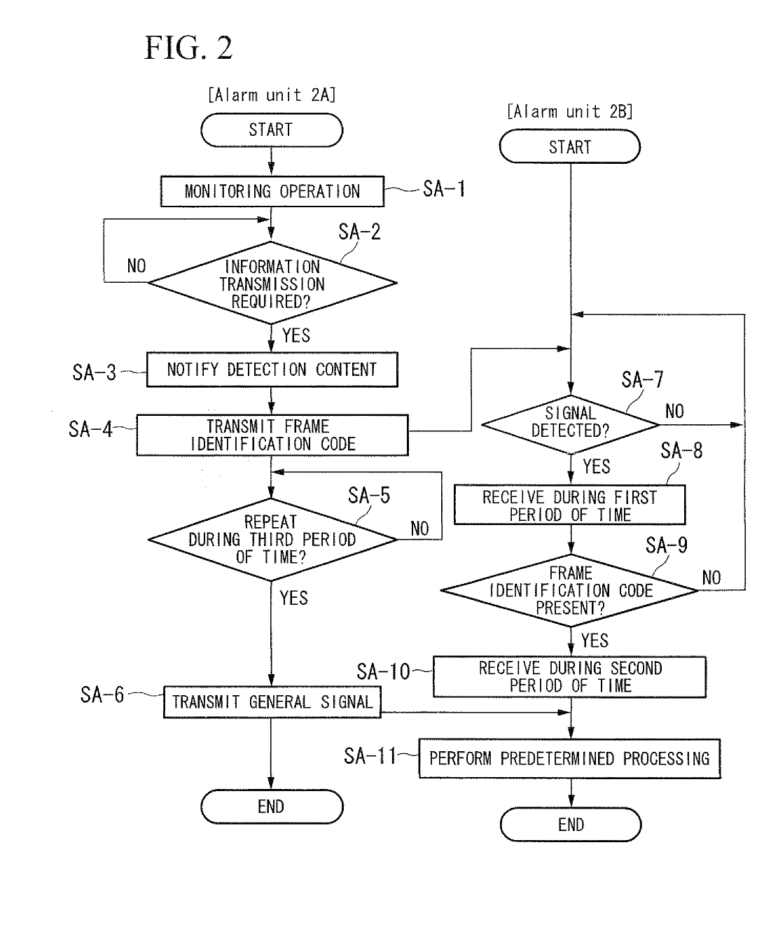

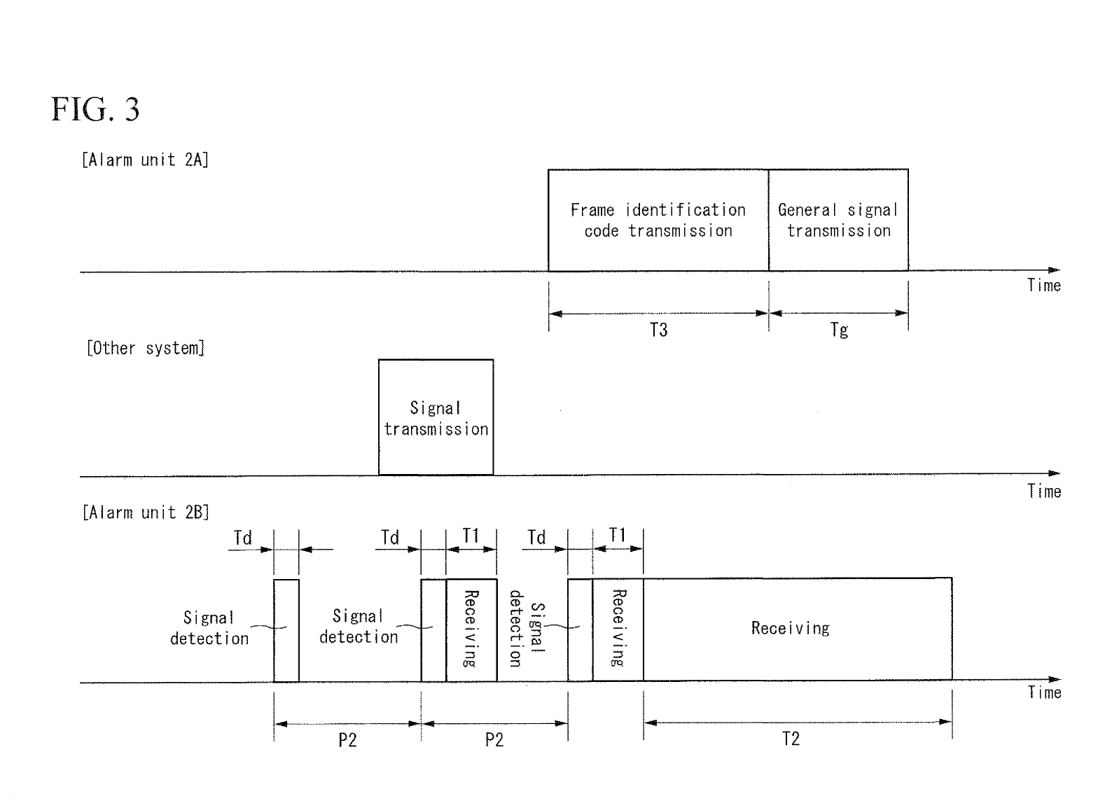

Next, there are described the contents of processing executed by the control section 23. Here, there is described a case of an example where two alarm units 2A and 2B are installed in a house or the like, and signals are transmitted from the alarm unit 2A. FIG. 2 is a flowchart showing flows of the processing executed by the control section 23, and FIG. 3 is a timing chart showing timings of signal transmission/reception to be made between the alarm units 2A and 2B. In FIG. 3, the horizontal axis represents time and the vertical axis represents presence/absence of signals.

If a monitoring state of the alarm unit 2 is started by a predetermined input operation, the sensor section 20 executes an operation of monitoring the area within a monitoring region (step SA-1). In a case where information needs to be transmitted to other alarm units 2 including the alarm unit 2B, for example, when the sensor section 20 of the alarm unit 2A has detected a fire or some kind of fault occurs (step SA-2, Yes), the control section 23 of the alarm unit 2A controls the notifying section 21 to notify the content of the detection, the state of the fault, or the like, based on a detection signal or the like output from this sensor section 20 (step SA-3). Meanwhile, the transmission control section 31 transmits, through the transmitting section 30, a frame identification code as a signal of a predetermined frequency to the alarm unit 2B (step SA-4). At this time, the transmission control section 31 repeatedly transmits the frame identification code during the third period of time (T3 in FIG. 3) (step SA-5). Having transmitted the frame identification code (step SA-5, Yes), the transmission control section 31 transmits a general signal during a predetermined period of time (Tg in FIG. 3) (step SA-6).

Moreover, if the monitoring state of the alarm unit 2 is started, the reception control section 41 controls the receiving section 40 to detect the presence or absence of the signal of the predetermined frequency (step SA-7). At this time, as shown in FIG. 3, the reception control section 41 causes the signal detection to be performed in the second period (P2 in FIG. 3), which is shorter than the third period of time described above. Thereby, the receiving unit 4 can, with the receiving section 40, receive this frame identification code at least once during the third period of time T3, during which the frame identification code is transmitted. An amount of time required for signal detection (Td in FIG. 3) is arbitrary, however, there is no need for analyzing the content of the signal and it is consequently possible to make it shorter than the first period of time described later.

As a result, in a case where a signal of the predetermined frequency is detected (step SA-7, Yes), the reception control section 41 controls the receiving section 40 to receive this signal of the predetermined frequency during the first period of time (T1 in FIG. 3) (step SA-8), performs processing for analyzing the received signal, and determines whether or not this signal contains the frame identification code (step SA-9).

The alarm unit 2A repeatedly transmits the frame identification code as the signal of the predetermined frequency. Where the data size of this frame identification code is N bits and the communication speed between the alarm units 2A and 213 is S bits per second, the amount of time required for a single transmission of the frame identification code is expressed as N/S seconds. Therefore, in order to determine whether or not the signal received by the reception control section 41 contains the frame identification code, the first period of time T1, during which the receiving section 40 is to receive the signal, is set as a period of time longer than N/S seconds.

In a case where the signal received by the receiving section 40 is a signal, as with the signal transmitted from another system in FIG. 3, that does not contain the frame identification code (step SA-9, No), the reception control section 41 determines that this signal does not require further analysis, and it controls the receiving section 40 again to detect the presence or absence of the signal of the predetermined frequency (step SA-7).

On the other hand, in a case where the signal received by the receiving section 40 contains the frame identification code (step SA-9, Yes), the reception control section 41 determines that the received signal is a signal transmitted to the alarm unit 2B and contains information that requires further analysis. Then the reception control section 41 controls the receiving section 40 to receive the signal of the predetermined frequency during the second period of time (T2 in FIG. 3), and performs processing of analyzing the received signal (step SA-10).

As described above, the frame identification code is repeatedly transmitted during the third period of time T3, and after this, the general signal is transmitted during the predetermined period of time Tg. Therefore, in order to confirm that the received signal contains the frame identification code, then receive the general signal, and analyze it, the reception control section 41 of the alarm unit 2B needs to control the receiving section 40 to continue to perform reception until the general signal, which is transmitted following the frame identification code, is received at least. Consequently, the second period of time T2 is set as a period of time longer than the third period of time T3. As described above, the third period of time T3 is a period of time, during which the frame identification code is repeatedly transmitted, and is longer than the first period of time T1, which is a period of time required for receiving the frame identification code once. Therefore, the second period of time T2, which is longer than this third period of time T3, is naturally longer than the first period of time T1.

The control section 23 of the alarm unit 2B executes a predetermined processing such as alarm notification, based on the results of the processing for analyzing the signal received by the receiving section 40.

### (Effect of Embodiment 1)

As described above, according to this embodiment 1, the receiving unit 4, in a case where it has detected a signal of the predetermined frequency, first receives the signal during the first period of time T1, which is required for determining whether or not this signal contains the frame identification code. Then, in a case where the frame identification code is contained, it continues to perform the receiving operation and analysis of the content of the signal, and it receives the signal during the second period of time T2, which is longer than the first period of time T1. Therefore, in a case where the frame identification code is not contained, the receiving operation may be performed only during the first period of time T1 and the amount of time for performing the receiving operation can be reduced during the second period of time T2. Consequently, it is possible to reduce electric power consumption of the receiving unit 4.

Moreover, the transmission control section 31 repeatedly transmits the frame identification code during the third period of time T3, and the reception control section 41 causes the signal detection to be performed during the second period P2, which is shorter than the third period of time T3. Consequently, it is possible, with the receiving section 40, to receive this frame identification code at least once during the third period of time T3, during which the frame identification code is transmitted. Therefore, in a case where a signal is transmitted from the transmitting unit 3, it is possible to have the receiving unit 4 immediately detect this signal, receive and analyze the frame identification code, and receive the following general signal. Consequently, real-time performance of the communication can be increased.

Moreover, since the second period of time T2 is longer than the third period of time T3, the reception control section 41 can control the receiving section 40 to continue to perform the receiving operation until the general signal, which is transmitted following the repeatedly transmitted frame identification code, has been received, to thereby reliably receive the general signal.

### Embodiment 2

Next, an embodiment 2 of the present invention is described. In this embodiment, a receiving device performs signal detection in a period that is longer than the time for transmission of the second signal performed by a transmitting device.

The configuration of this embodiment 2 is substantially the same as the configuration of the above embodiment 1 unless otherwise specified, and for the configuration substantially the same as that of the above embodiment 1, the same reference symbols and/or names used in the above embodiment 1 are given as necessary, and the description thereof is omitted.

### (Detection of Signal of Predetermined Frequency in Receiving Section 40)

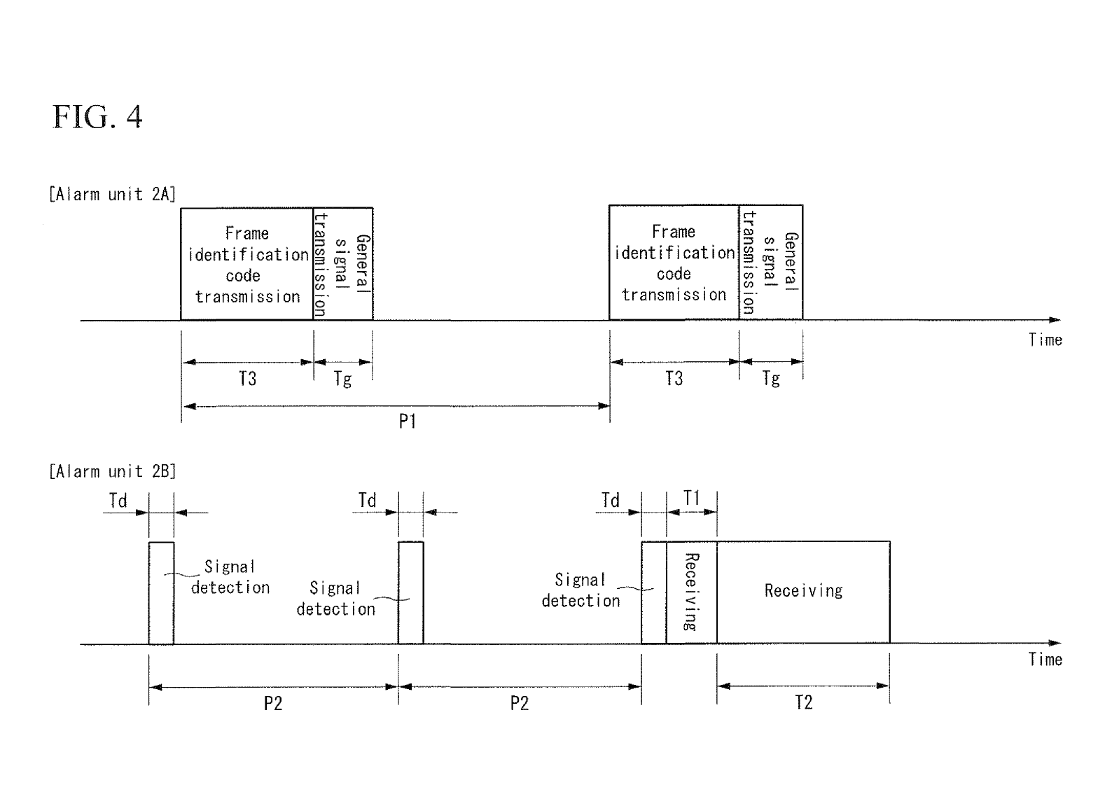

A communication system according to this embodiment 2 is characterized by the timing at which the reception control section 41 controls the receiving section 40 to detect the presence or absence of a signal of a predetermined frequency. FIG. 4 is a timing chart showing timings at which signal transmission/reception is made between the alarm units 2A and 2B.

As with the step SA-4 in FIG. 3 of the above embodiment 1, in a case where it becomes necessary to transmit information from the alarm unit 2A to another alarm unit 2, the transmission control section 31 of the alarm unit 2A repeatedly transmits a frame identification code in each first period (P1 in FIG. 4) during the third period of time (T3 in FIG. 4). Having transmitted the frame identification code, the transmission control section 31 transmits a general signal during a predetermined period of time (Tg in FIG. 4).

On the other hand, the reception control section 41 of the alarm unit 2B controls the receiving section 40 to detect the presence or absence of the signal of the predetermined frequency. At this time, as shown in FIG. 4, the reception control section 41 causes the signal detection to be performed in the second period (P2 in FIG. 4), which is longer than the third period of time T3 and different from the first period P1. In a case where the transmission of the frame identification code performed by the transmission control section 31 and signal detection performed by the reception control section 41 are respectively repeated in the above periods and the receiving unit 4 performs the operation of signal detection while the frame identification code is being transmitted, this receiving unit 4 detects the frame identification code.

### (Effect of Embodiment 2)

As described above, according to this embodiment 2, the transmission control section 31 repeatedly transmits the frame identification code in each first period P1 during the third period of time, and the reception control section 41 causes the signal detection to be performed in the second period P2, which is longer than the third period of time T3 and different from the first period P1. Therefore, in a case where the timing of frame identification code transmission performed by the transmission control section 31 matches the timing of signal detection performed by the reception control section 41, it is possible, with the receiving section 40, to receive the frame identification code. Accordingly, it is possible to reduce the frequency of the signal detection operation performed by the receiving section 40, and to reduce electric power consumption.

### Embodiment 3

Next, an embodiment 3 of the present invention is described. In this embodiment, in a case where a signal of a predetermined frequency is detected several times, this signal is received.

The configuration of this embodiment 3 is substantially the same as the configuration of the above embodiment 1 unless otherwise specified, and for the configuration substantially the same as that of the above embodiment 1, the same reference symbols and/or names used in the above embodiment 1 are given as necessary, and the description thereof is omitted.

### (Processing Performed by Control Section 23)

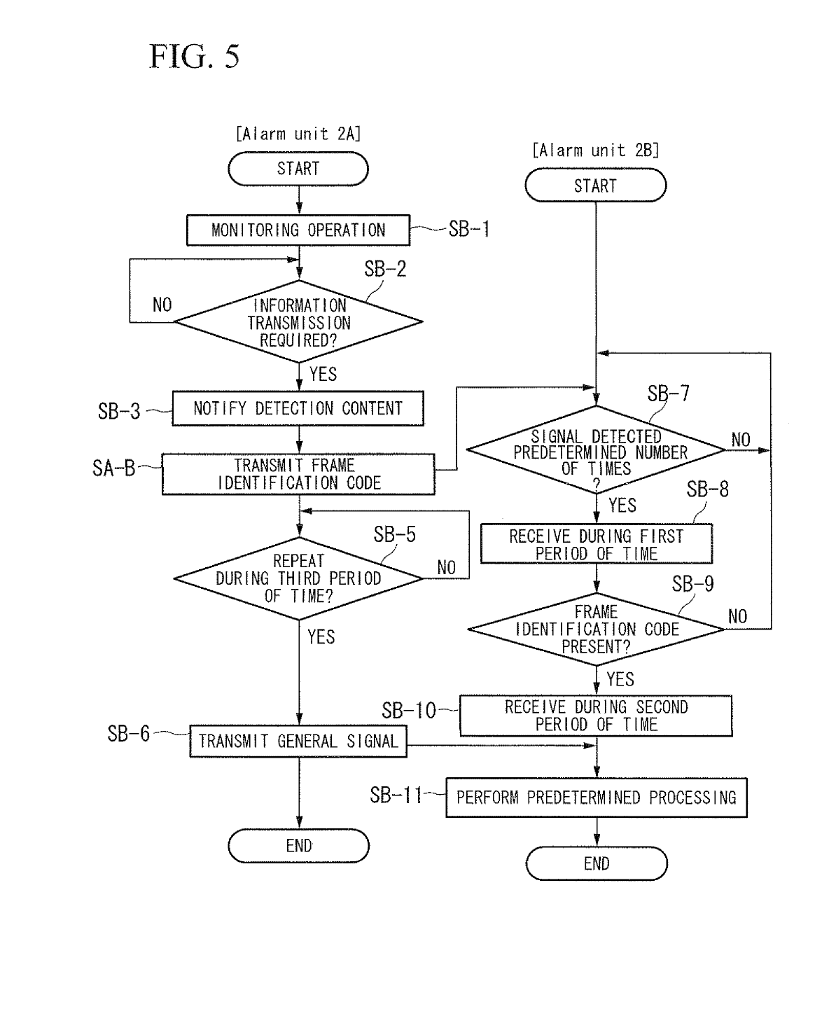

There is described the content of the processing executed by the control section 23 according to this embodiment 3. Here, as with the description in the above embodiment 1, there is described a case of an example where two alarm units 2A and 2B are installed in a house or the like and signals are transmitted from the alarm unit 2A. FIG. 5 is a flowchart showing flows of processing executed by the control section 23. Steps SB-1 to SB-11 described below except for step SB-7 are similar to the steps SA-1 to SA-11 in FIG. 2 described in the above embodiment 1, and the descriptions thereof are therefore omitted. Moreover, the timings at which signals are transmitted between the alarm units 2A and 2B are similar to the timings described in the above embodiment 1 with reference to FIG. 3.

If the monitoring state of the alarm unit 2 is started in step SB-1, the reception control section 41 controls the receiving section 40 to detect the presence or absence of the signal of the predetermined frequency (step SB-7). At this time, as shown in FIG. 3, the reception control section 41 causes the signal detection to be performed in the second period P2, which is shorter than the third period of time T3. In a case where the signal of the predetermined frequency is detected a predetermined number of times in the detection operation performed a predetermined number of times (step SB-7, Yes), for example, in a case where the signal of the predetermined frequency has been detected three times while performing the detection operation five times, the reception control section 41 controls the receiving section 40 to receive this signal of the predetermined frequency during the first period of time T1 (step SB-8). On the other hand, in a case where the number of detections of the signal of the predetermined frequency is less than the predetermined number of times (step SB-7, No), the reception control section 41 determines that the signal of the predetermined frequency is not being transmitted and controls the receiving section 40 again to detect the presence or absence of the signal (step SB-7).

### (Effect of Embodiment 3)

As described above, according to this embodiment 3, in a case where the receiving section 40 has detected the signal of the predetermined frequency the predetermined number of times, the reception control section 41 controls the receiving section 40 to receive this signal. Accordingly, it is possible, only in a case where it is determined that the signal of the predetermined frequency is being reliably transmitted, to have the receiving section 40 perform the receiving operation. Consequently, it is possible to suppress the number of performances of the receiving operation to a bare minimum while reducing electric power consumption.

### [III] Modified Example of Respective Embodiments

The respective embodiments according to the present invention have been described. However, the specific configurations and measures of the present invention may be modified or improved arbitrarily without departing from the spirit and scope of the technical concept of the respective aspects of the invention disclosed in the claims.

### (About Problems to be Solved and Effect of the Invention)

The problems to be solved by the present invention and the effects of the invention are not to be considered limited only by the aforementioned contents, and the present invention may solve problems that are not disclosed above or may achieve effects that are not disclosed above. Moreover, the present invention, in some cases, may only solve part of the disclosed problems or may achieve part of the disclosed effects.

### INDUSTRIAL APPLICABILITY

A communication system according to the present invention may be applied to a communication system that performs communications by transmitting and receiving signals, and it is in particular useful for a communication system that enables reliable signal reception within a local system, reduces operating time of a receiving unit and control unit, and enables reduction in electric power consumption.

1. A communication system comprising a transmitting unit and a receiving unit, wherein
the transmitting unit is provided with:
a transmitting device that performs transmission of signals of a predetermined frequency; and
a transmission control device that through the transmitting device, transmits a first signal containing predetermined information, and a second signal that contains identification information for identifying the receiving unit, to which this first signal is to be transmitted, and that requires, for analyzing this signal, an amount of processing less than that required for the first signal, and
the receiving unit is provided with:
a receiving device that detects the presence or absence of the signal of the predetermined frequency and that receives this signal of the predetermined frequency; and
a reception control device that, in a case where this receiving device has detected the signal of the predetermined frequency, controls the receiving device to receive this signal of the predetermined frequency only during a first period of time, that determines whether or not the signal received by the receiving device contains the second signal, and that, in a case where this second signal is contained, controls the receiving device to receive the signal of the predetermined frequency only during a second period of time, which is longer than the first period of time.

2. The communication system according to claim 1, wherein:
the transmission control device repeatedly transmits the second signal only during a third period of time; and
the reception control device controls the receiving device to detect the signal of the predetermined frequency in a second period, which is shorter than the third period of time, and that, in a case where the signal received by the receiving device contains the second signal, controls the receiving device to receive the signal of the predetermined frequency only during the second period of time, which is longer than the first period of time and the third period of time.

3. The communication system according to claim 1, wherein:
the transmitting unit repeatedly transmits the second signal in each first period only during a third period of time, which is shorter than the first period; and
the reception control device controls the receiving device to detect the signal of the predetermined frequency in the second period, which is longer than the third period of time and different from the first period, and that, in a case where the signal received by the receiving device contains the second signal, controls the receiving device to receive the signal of the predetermined frequency only during the second period of time, which is longer than the first period of time and the third period of time.

4. The communication system according to any one of claims 1 to 3, wherein:
the reception control device, in a case where the receiving device has detected the signal of the predetermined frequency several times, controls the receiving device to receive the signal of the predetermined frequency.
